(19) United States
(12) Patent Application Publication
(10) Pub. No.: US 2005/0072433 A1
(43) Pub. Date: Apr. 7, 2005

(54) Open style head restraint with closeout and method for making same

(75) Inventor: Karsten Ingwersen, Howell, MI (US)

Correspondence Address: HONIGMAN MILLER SCHWARTZ AND COHN LLP, 32270 TELEGRAPH RD, SUITE 225, BINGHAM FARMS, MI, 48025-2457, US

(73) Assignee: Intier Automotive, Aurora Ontario, Canada (CA)

(21) Appl. No.: 10/493,363

(22) PCT Filed: Oct. 21, 2002
(86) PCT No.: PCT/US02/33435

Related U.S. Application Data
(60) Provisional application No. 60/335,707, filed on Oct. 22, 2001.

(51) Int. Cl. A61G 15/00

(52) U.S. Cl. 128/845

(57) ABSTRACT

An open style head restraint includes a closeout for providing structural integrity and safety. For providing maximum visibility, the closeout is preferably made of see-through material, for example, cellular material, such as mesh or net material, or non-cellular material, such as clear and semi-transparent plastic material, or the like. The open style head restraint is formed by affixing the closeout between the armatures and/or a top or bottom cross member. Next, a sealing material is applied between the closeout and the mold assembly to prevent the foam filler from seeping onto the closeout. Then, a release-mold coat, an in-coat, and a skin coat can be applied to the mold halves. Next, the closeout is properly positioned in the mold assembly and the armatures are secured. The foam filler is then injected while the mold assembly is in the closed position. Then, the foam filler is allowed to cure. After a sufficient period of time, the completed open style head restraint with closeout can be removed from the mold assembly.

### BACKGROUND OF THE INVENTION

1. Field of the Invention

The invention is generally related to a head restraint, and in particular to an open style head restraint with a closeout for both aesthetic and/or structural purposes, and a method for making same.

2. Description of the Related Art

Recent legislation has required vehicle seat head restraints to extend higher in vehicles for improved safety. For example, European legislation requires that the top of the head restraint be positioned 750 mm above the hip pivot point, which is substantially higher than most current designs. As a result of these tall seat designs, either the seat back is made taller and/or the head restraint is made taller. Because a taller seat back may obstruct the view of the occupant, it is preferred that the head restraint is made taller to maximize visibility.

With a taller or larger head restraint design, the dimensions of the halo or opening may be sufficiently large that a portion of the occupant, such as the head of a child, an arm of an adult, or the like may become lodged in the halo during accident conditions. The inventor of the present invention has recognized this problem and has developed a closeout to be mounted within the opening of the head restraint. The closeout can be designed to provide an aesthetic appearance by incorporating a design on the closeout and/or structural integrity to the head restraint by preventing the portion of the occupant to become lodged in the halo during accident conditions.

In addition, a problem associated with the manufacture is that the foam filler material has a tendency to seep or leek onto the closeout during the manufacture of the head restraint, thereby reducing the aesthetic appearance of the head restraint. The inventor has recognized this problem and has developed a method of preventing the foam filler material from seeping onto the closeout during the manufacturing process.

### SUMMARY OF THE INVENTION

The invention is directed to an open style head restraint with a closeout and a method of making the head restraint. The closeout can be made of any desired material that maximizes visibility while preventing a portion of the occupant to become lodged in the halo during accident conditions. For example, the closeout can be made of a cellular type material that maximizes the visibility through the opening, such as a mesh, net, or the like. Preferably, the closeout is attached to the armature and/or the cross member to hold the closeout in place during manufacture of the head restraint. This can be accomplished by any means, such as attaching the closeout to armatures, posts, or the like. An advantage of using the cellular type material, such as the mesh, is that the material may become bonded to the foam filler during manufacture of the head restraint without the need of attaching the closeout to the armature and/or cross member during the manufacturing process. Other materials that can be used for the closeout include, but is not limited to, clear or semi-transparent plastic or plexiglass material. It should be noted that the closeout material also provides structural support for the head restraint and can absorb energy from the occupant during accident conditions.

Another problem solved by the inventor is preventing the foam filler material from leaking onto the closeout during manufacture of the head restraint. To solve this problem, the inventor has discovered a sealing means for sealing the closeout from the foam filler during manufacture of the head restraint. Specifically, the sealing means preferably comprises a non-permeable material that is positioned between the cutting ridges and projections of the mold assembly to form a seal between the closeout and the mold cavity. The non-permeable material may be any desired material that is capable of forming a seal between the closeout and the foam filler. For example, it has been shown that wax paper comprises an acceptable non-permeable material. To hold the wax paper in place during manufacture, a double-side tape can be placed between the wax paper and the closeout. Other examples of non-permeable material include rubber-like material, or the like, that can be aligned with the cutting ridge and projection to effectively seal the foam filler from seeping onto the closeout during manufacture of the head restraint.

### BRIEF DESCRIPTION OF THE DRAWINGS

In the drawings:

FIG. 1 is a side perspective view of the mold assembly according to an embodiment of the invention;

FIG. 2 is a front elevational view of the armature and the cross member looped through the closeout material;

FIG. 3 is a front elevational view of the armature, the cross member, and the closeout of FIG. 2 with the non-permeable material and attaching means for keeping the non-permeable material in place during the manufacturing process;

FIG. 4 is a perspective view of applying a mold-release coat to one of the mold surfaces while the mold assembly is in an open position;

FIG. 5 is a perspective view of applying an in-mold coat to one of the mold surfaces while the mold assembly is in the open position;

FIG. 6 is a perspective view of applying a skin coat to one of the mold surfaces while the mold assembly is in the open position;

FIG. 7 is a perspective view of positioning the closeout material over the respective cutting ridge and projection by inserting the armatures into their respective channels in one half of the mold assembly;

FIG. 8 is a perspective view of FIG. 7, but showing both mold halves of the mold assembly;

FIG. 9 is a perspective view of injecting the foam filler through the funnel and into the mold assembly while rotated 90-degrees in the closed position;

FIG. 10 is a perspective view of allowing the foam filler to expand while the mold assembly is in the rotated, closed position;

FIG. 11 is a top view of the mold assembly when in the open position after the foam filler is allowed to expand showing the completed halo style head restraint while in the mold assembly;

FIG. 12 is a front elevational view of the completed halo style head restraint when removed from the mold assembly; and

FIG. 13 is a front elevational view of a completed open style head restraint according to an alternate embodiment of the invention.

### DESCRIPTION OF THE PREFERRED EMBODIMENT

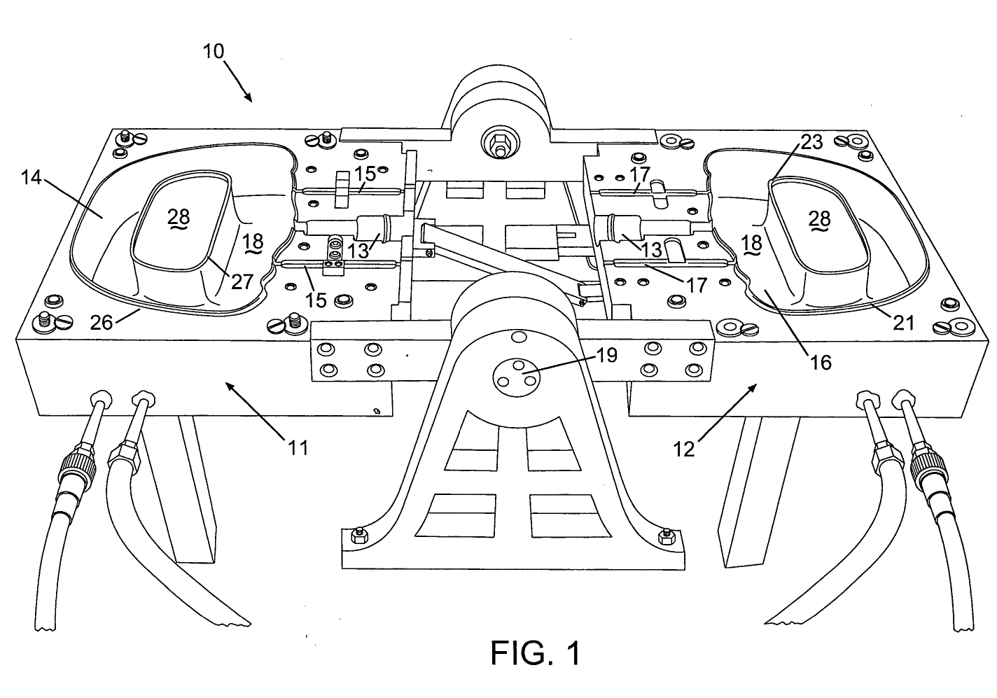

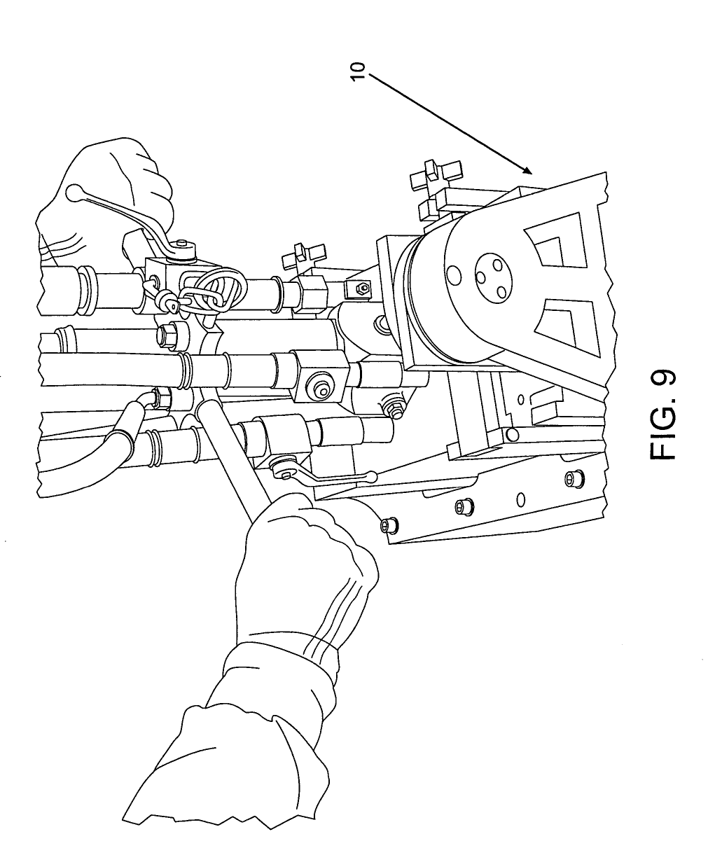

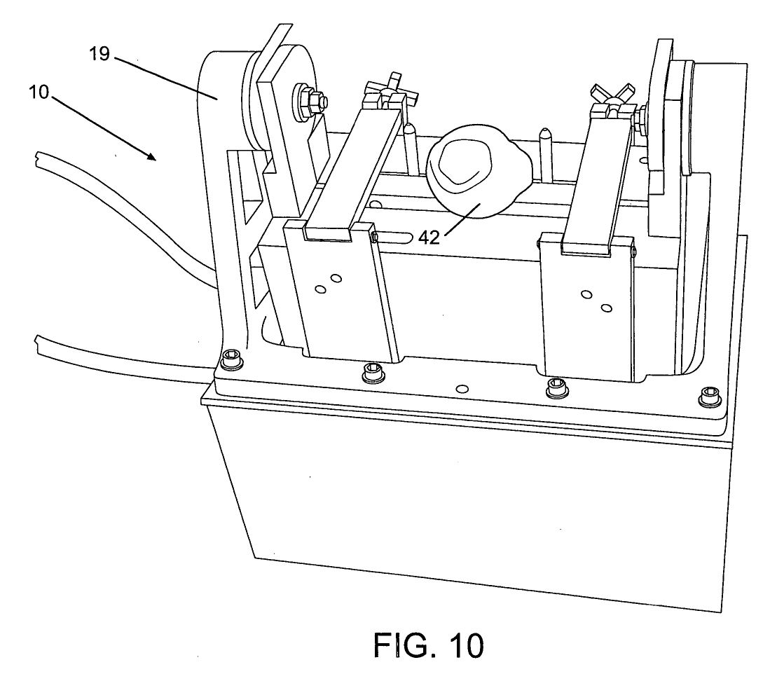

Referring to FIG. 1, the mold assembly 10 includes a first mold half 11 and a second mold half 12. The mold halves 11, 12 are movable relative to each other between an open position, as shown in FIGS. 1, 4-8 and 11, and a closed position, as shown in FIGS. 9 and 10. The first and second mold halves 11, 12 include first and second contoured mold surfaces 14, 16, respectively. The mold surfaces 14, 16 are concave and complimentary to each other such that the molded surfaces 14, 16 define a substantially enclosed mold cavity 18 when the mold assembly 10 is in the closed position. The surfaces of the mold surfaces 14, 16 defining the mold cavity 18 correspond to an outer contour of the head restraint (not shown in the Figures). The mold surfaces 14, 16 preferably include a textured surface that forms a final surface texture of the head restraint. It should be appreciated that while the mold surfaces 14, 16 are illustrated as concave, the mold surfaces 14, 16 may be of any suitable shape so as to define a cavity commensurate with the desired shape of the head restraint.

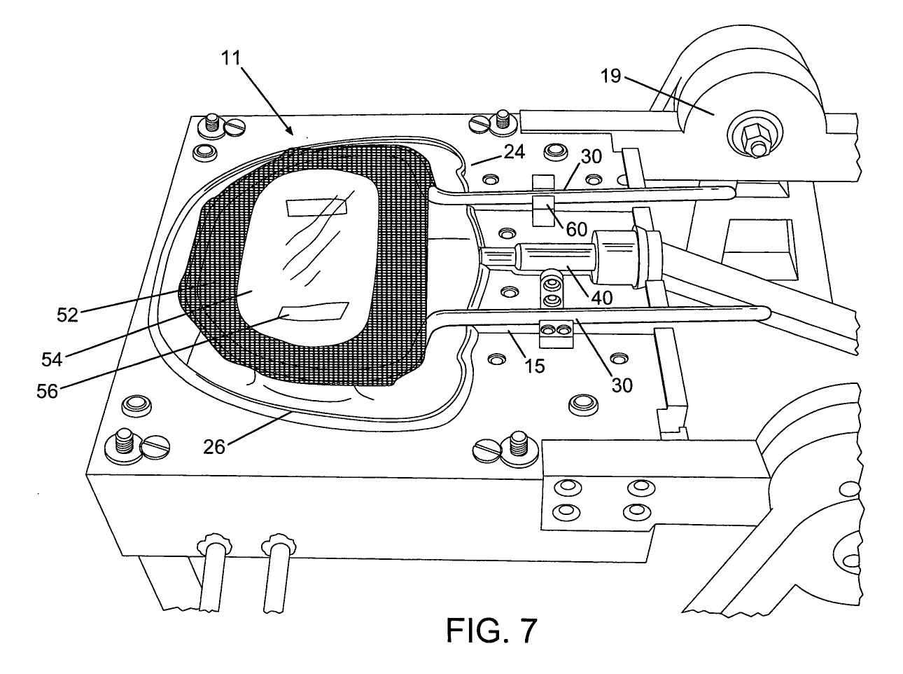

The mold halves 11, 12 further include first and second receiving recessed channels 15, 17, respectively. In the illustrated embodiment, a hinge 19 interconnects the mold halves 11, 12 for providing pivotal movement of the mold halves 11, 12 between the open and closed positions. It will be appreciated that the hinge 19 is optional, and that the mold assembly 10 may alternatively be placed in the closed position by moving the mold halves 11, 12 relative to each other in any suitable manner including linear movement, arcuate movement or a combination linear and arcuate movements. The operation of these components will be described further hereinbelow. Additionally, a filler port 13 is disposed within each of the first 11 and second 12 mold halves, respectively, to receive an injection funnel 40 (FIG. 7), as will be discussed in greater detail below.

The second mold half 12 includes an outer, peripheral cutting ridge 21 surrounding the circumference of the opening defined by the second mold surface 16. The cutting ridge 21 is shown as a substantially triangular barb having a sharp leading edge. Alternatively, the cutting ridge 21 may have any shape or configuration suitable for performing a cutting operation described below.

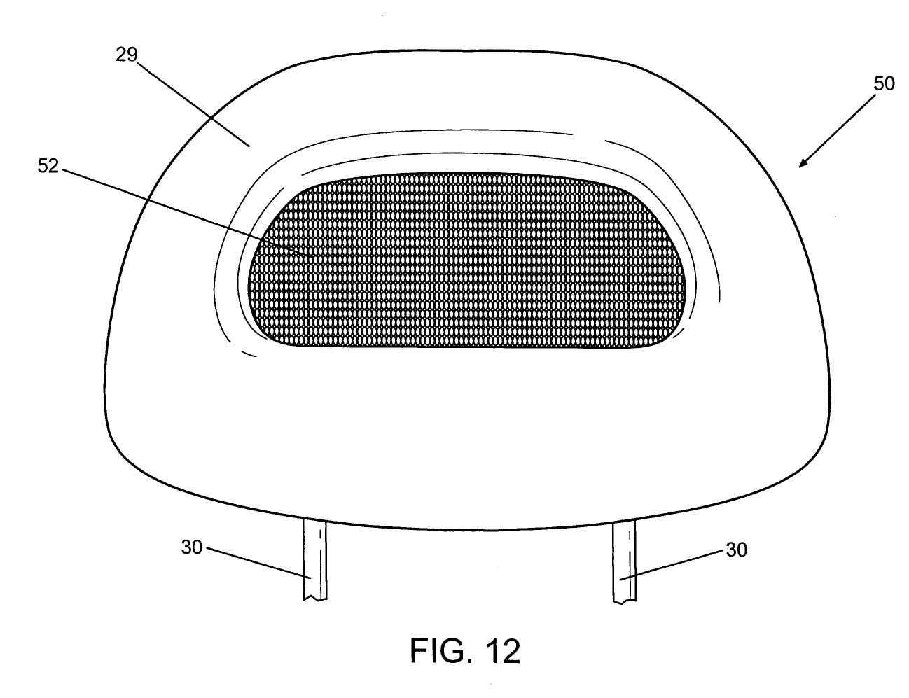

The second mold half 12 also includes an inner, peripheral cutting ridge 23 surrounding the circumference of a central portion 28 of the second mold surface 16 that defines the halo of the head restraint 50 (FIG. 12). Similar to the cutting ridge 21, the cutting ridge 23 may comprise a substantially triangular barb having a sharp leading edge.

The first mold half 11 includes an outer projection or lip 26 extending from and surrounding the circumference of the opening defined by the first mold surface 14. The outer projection 26 acts as cutting board for the outer cutting ridge 21 as further described below. The first mold half 11 also includes an inner projection or lip 27 extending from and surrounding the circumference of the central portion 28 of the first mold surface 14 that defines the central opening or halo of the head restraint 50 (FIG. 12). Similar to the outer projection 26, the inner projection 27 acts as cutting board for the inner cutting ridge 23 as further described below.

The illustrated embodiment of the invention is shown as a “halo” style head restraint design. As used herein, the “halo” is defined by the central opening of the doughnut-shaped head restraint 50. However, the invention is not limited to a “halo” style head restraint design. In particular, the invention can be practiced with any open style head restraint design in which the head restraint does not include a central opening formed by a closed loop. For example, the invention can be practiced with a head restraint design in which an opening is formed between a pair of upright posts without a top and/or bottom member connecting the posts of the head restraint together.

A method of forming the halo style head restraint 50 with a closeout 52 will now be described. In the illustrated embodiment, the closeout 52 is made of a mesh or net material. However, it will be appreciated that the invention is not limited by the material used for the closeout, and that the invention can be practiced by using a closeout made of any desired material. For example, the closeout 52 may be made of a cellular material as shown in the illustrated embodiment, such as a net, mesh, or the like. Alternatively, the closeout 52 may be made of a non-cellular or substantially solid material, such as a plastic, fiberglass, or the like. For safety, the closeout 52 may add structural integrity to the head restraint 50 for absorbing energy during impact. In addition, the closeout 52 may have a “see-through” property to allow the occupant to have a substantially unobstructed view through the halo of the head restraint 50.

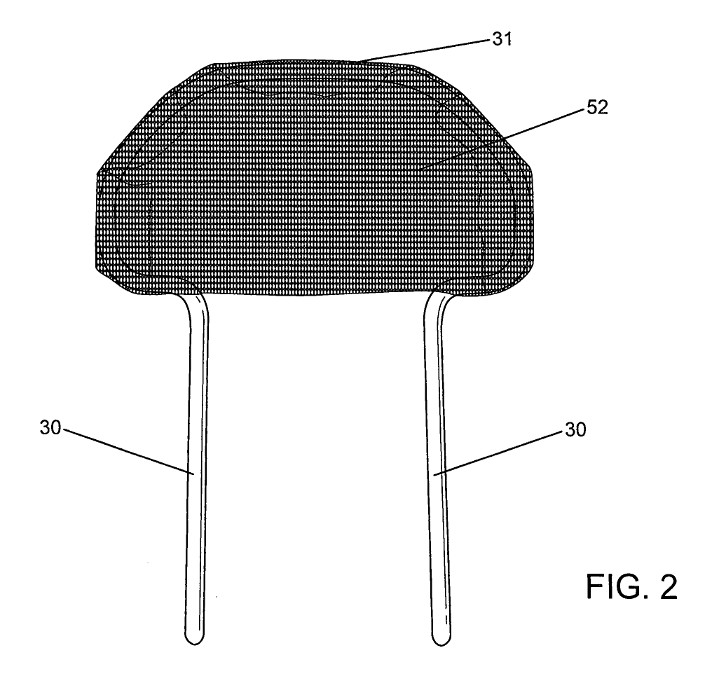

Initially, the closeout 52 is supported by the armatures 30 such that the closeout 52 will stay in place during the forming of the head restraint 50, as shown in FIG. 2. Preferably, the closeout 52 is supported by a cross member 31 that forms a U-shaped support for the armatures 30. The U-shaped support 31 may be an integral U-shaped tube having a solid or hollow construction, as shown in FIG. 2. Alternatively, the U-shaped support 31 may have a pair of separate armature posts 30 connected to a separate cross member by any suitable attachment means. In addition, there may be two separated armatures 30 without a cross member, or even a single armature 30.

The closeout 52 can be supported by the cross member 31 in several different ways. One way is to sew or fasten the ends of the closeout 52 together to form a loop having a sufficient diameter to allow each armature 30 and the cross member 31 to slide therethrough. Another way to support the closeout 52 by the cross member 31 is to apply heat and pressure to the ends of the closeout 52, thereby fastening the ends of the closeout 52 together. After the ends after fastened together, each armature 30 and the cross member 31 can be slid through the fastened ends of the closeout 52. Yet another way is to apply hot glue to the ends of the the closeout together.

It will be appreciated that it is not important to the invention that the ends of the closeout 52 are fastened together prior to sliding each armature 30 and the cross member 31 through the bonded ends. For example, the ends of the closeout 52 can be wrapped around each armature 30 and the cross member 31 prior to bonding the ends of the closeout 52 together. It will also be appreciated that the invention is not limited by the method in which the closeout 52 is held in place during the formation of the head restraint 50. For example, the closeout 52 may not be supported by the cross member 31 or each armature 30, but rather placed on top of the central portion of either the first or second mold half 11, 12 in such a manner as to prevent the closeout 52 from moving during the formation of the head restraint 50. In another example, the first or second mold half 11, 12 may include one or more pins or posts (not shown) to prevent the closeout 52 from moving during formation of the head restraint 50.

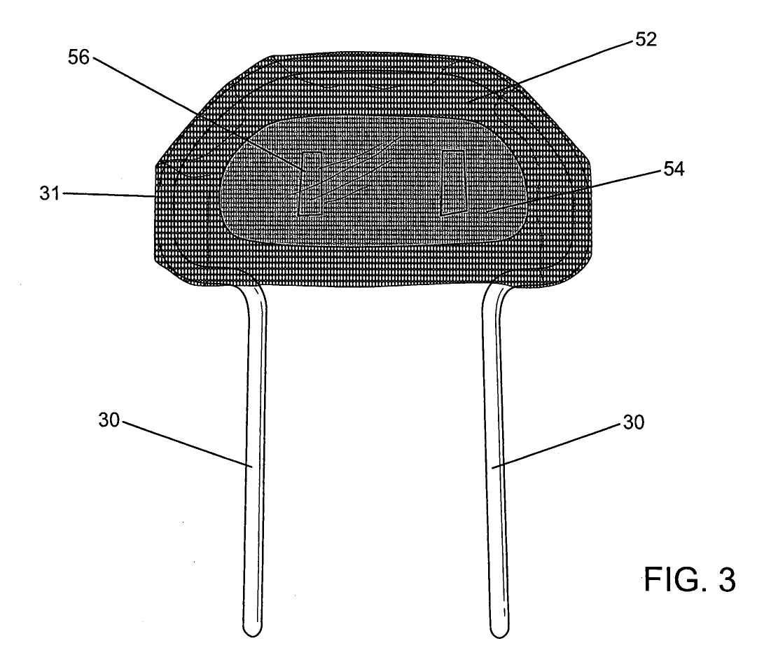

Next, a substantially non-permeable material 54 is placed on one or both sides of the closeout 52, preferably in a center portion of the closeout 52, as shown in FIG. 3. The purpose of the non-permeable material 54 is to provide a seal with the inner cutting ridge 23 and the inner projection 27 to prevent the foam filler 42 (FIG. 10) from seeping onto the closeout 52 during formation of the head restraint 50. Thus, the dimensions of the non-permeable material 54 should be larger than the dimensions of the central portion 28 such that the non-permeable 54 will completely cover the central portion 28, the inner cutting ridge 23 and the inner projection 27. In this manner, the inner cutting ridge 23 and the inner projection 27 will contact the non-permeable material 54 during the formation of the head restraint 50.

In the illustrated embodiment, the non-permeable material 54 is made of wax paper material. The wax paper material should be prevented from moving during formation of the head restraint 50. This can be accomplished by a means for removably attaching the non-permeable material 54 to the closeout 52, such as one or more segments of double-sided adhesive tape 56 positioned between the closeout 52 and the wax paper material 54.

However, it will be appreciated that the invention is not limited by the type of non-permeable material, and that the invention can be practiced with any type of non-permeable material that can form a seal to prevent the foam filler 44 from seeping out onto the closeout 52 during formation of the head restraint 50. For example, a rubber-like material can be placed on one or both sides of the closeout 52 such the rubber-like material in such a manner so as to seal the inner cutting ridge 23 and the inner projection 27 formation of the head restraint 50.

It should be noted that the armatures 30, the cross member 31, the closeout 52, the non-permeable material 54, and the adhesive tape 56 forms a sub-assembly of the head restraint 50.

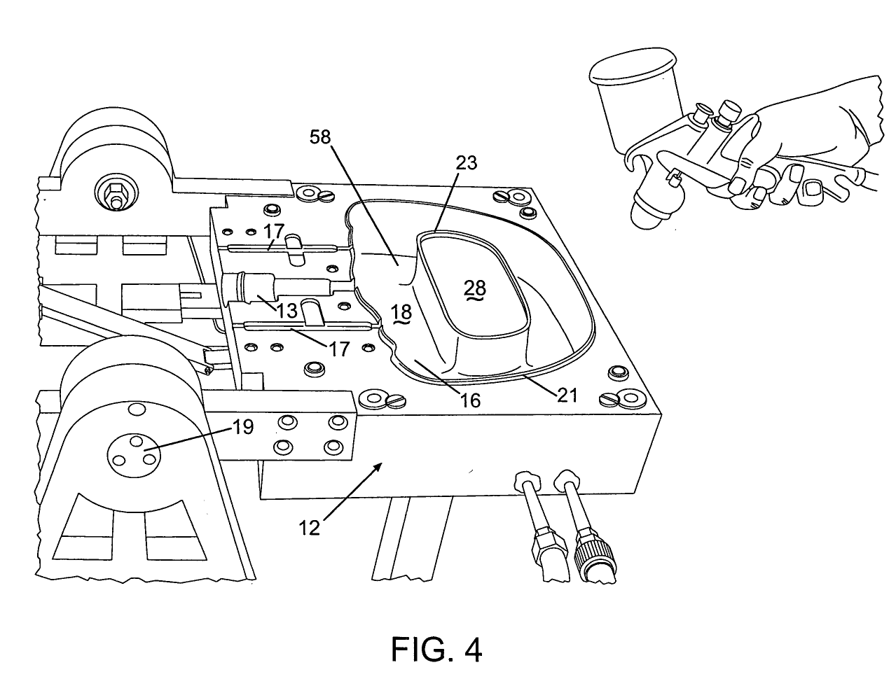

It is also optional that a mold-release coat 58 is applied to each of the mold surfaces 14, 16, as shown in FIG. 4. For brevity, the mold-release coat 58 is shown in FIG. 4 to be applied to only one mold surface 16. The purpose of the mold-release coat 58 is to promote efficient removal of the head restraint 50 from the mold assembly 10 after the forming process is complete.

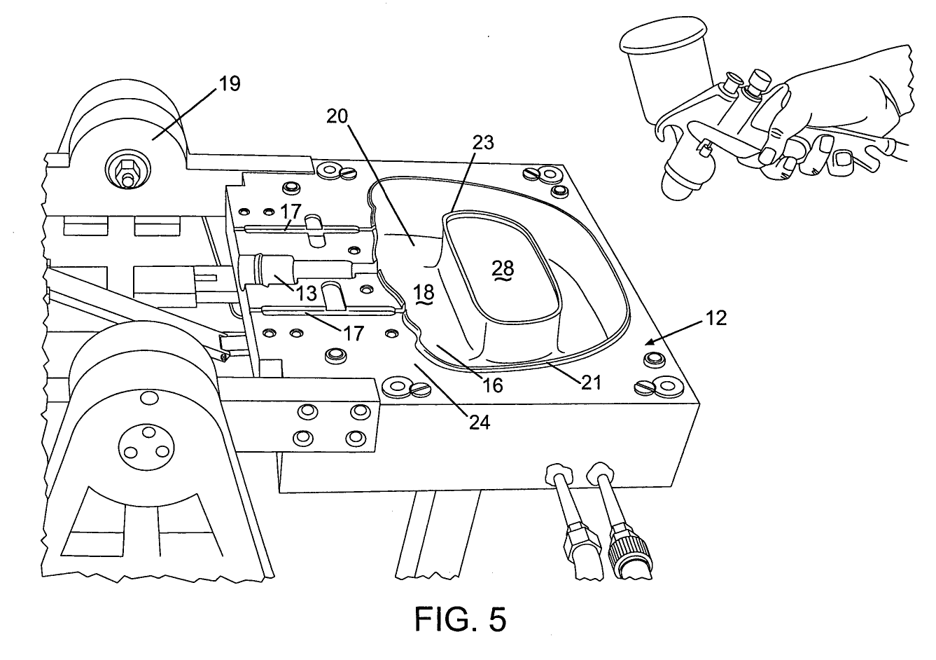

Then, an optional in-mold coat 20 is applied to the mold-release coat 58 on each of the mold surfaces 14, 16 when the mold assembly 10 is placed in the open position, as shown in FIG. 5. The in-mold coat 20 is preferably applied in a generally uniform manner to promote consistent gloss, texture, and color of the outer contour of the head restraint 50. Preferably, the in-mold coat 20 is a waterborne urethane coating, which can be applied by an air-atomized coating applicator such as a spray gun or bell applicator. Alternatively, the composition and means of applying the in-mold coat 20 may be of any suitable type.

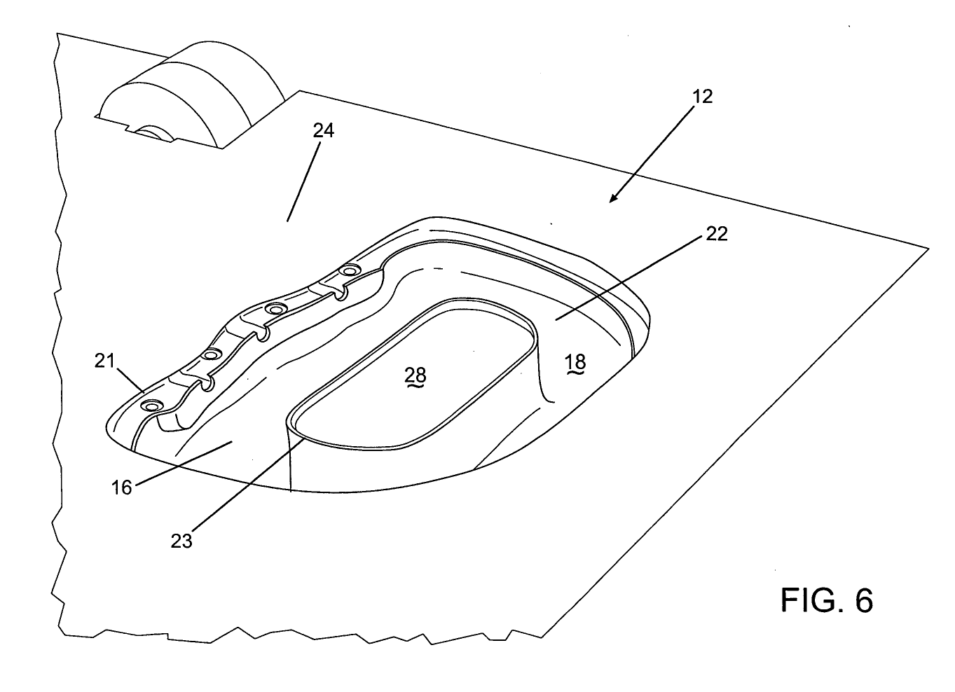

Next, a skin coat 22 is applied to the in-mold coat 20 in a manner similar to application of the in-mold coat 20, as shown in FIG. 6. The composition of the skin coat 22 is preferably a two component polyurethane elastomer including a polyol component and an isocyanate component as disclosed and described in U.S. Pat. No. 5,885,662 which is incorporated herein by reference in its entirety. The in-mold coat 20, which is applied to each mold half 11, 12, bonds to the respective skin coat 22 to form a structural skin 29 (FIG. 12). Depending on the formulation of the skin coat 22, the in-mold coat 20 can be eliminated from the process.

During the applications of the in-mold coat 20 and the skin coat 22, a certain amount of overspray 24 (FIGS. 5 and 6) can accumulate on the mold halves 11, 12 outside of the mold surfaces 14, 16 and outside of the outer cutting ridge 21 and outer projection 26.

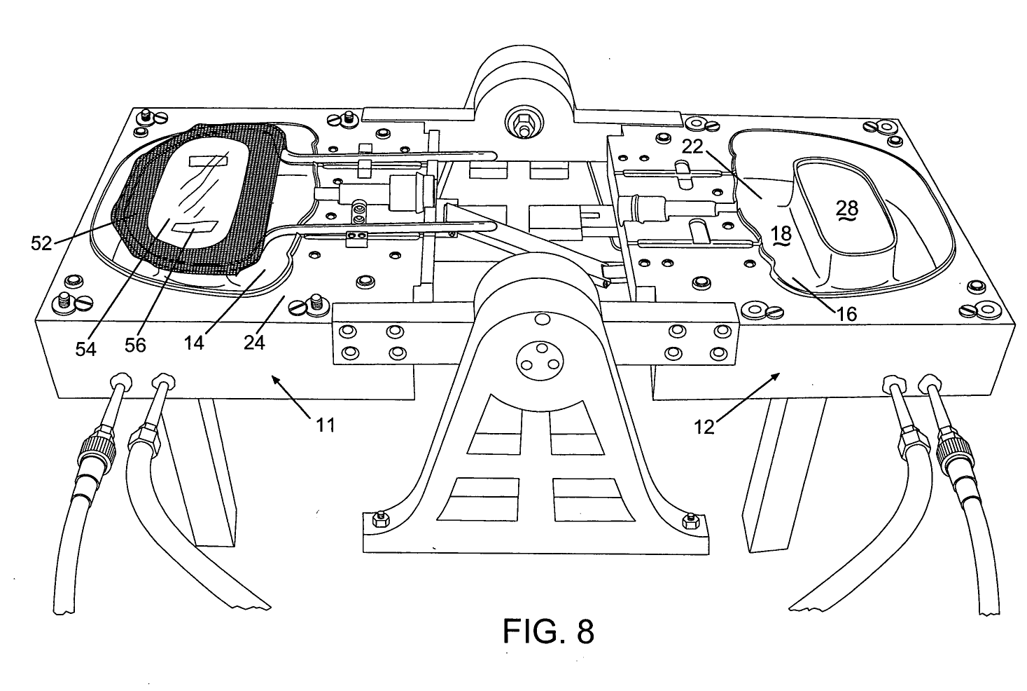

The armatures 30, the closeout 52 supported by the cross member 31, the non-permeable material 54 removably attached to the closeout 52 by the segments of tape 56 are then inserted into the respective receiving channels 15, 17 of a designated one of the mold halves 11, 12, as shown in FIGS. 7 and 8. This assembly should be positioned in the designated mold half 11, 12 such that the non-permeable material 54 is overlays the central portion 28 and inner cutting ridge 23 of mold half 12 or the inner projection 27 of mold half 11. Once positioned correctly, the armatures 30 can be held in place by a clamp 60, toggle, or the like. Once the mold-release coat 58, the in-mold coat 20 and skin coat 22 are applied and with the armatures 30 held in the respective receiving channels 15, 17, the injection funnel 40 is then inserted into the filler port 13 of the designated one of mold halves 11, 12.

The mold assembly 10 is then placed in the closed position as shown in FIG. 9 by rotating the second mold half 12 about the hinge 19. As the mold assembly 10 is placed in the closed position, the armatures 30 and the funnel 40 are received in the other receiving channel 15, 17 and the filler port 13, thereby enabling complete closure of the second mold half 12 relative to the first mold half 11.

As the mold halves 11, 12 are moved to the closed position, the outer cutting ridge 21 cuts through the overspray 24 of the coats 20, 22 on the mold halves 11, 12 and into abutment with the outer projection 26. The cutting ridge 21 and projection 26 extend around the entire perimeter of the mold cavity 18 such that any overspray 24 on the mold halves 11, 12 will be cut by the inner cutting ridge 21. Similarly, the inner cutting ridge 23 abuts the inner projection 27 such that the inner cutting ridge 23 cuts through the overspray 24 on the central portion 28 of the mold halves 11, 12. When the outer cutting ridge 21 abuts the outer projection 26 and the inner cutting ridge abuts the inner projection 27, the mold assembly 10 is in the closed position.

Before the mold halves 11, 12 are moved to the closed position, the coats 20, 22 are preferably allowed to at least partially harden to a non-liquid or gel state. The non-liquid or gel state of the coats 20, 22 promotes the cutting of the overspray 24 during the closing of the mold halves 11, 12.

Once the mold halves 11, 12 have reached, or just prior to reaching, the closed position, the mold halves 11, 12 are mechanically clamped or locked together to ensure that the mold assembly is properly placed and held in the closed position.

When in the closed position, the coats 20, 22 of the first mold half 11 bond with the coats 20, 22 of the second mold half 12 at the junction between the mold halves 11, 12. That is, the portion of the coats 20, 22 around the perimeter of the first mold surface 14 bond with the portion of the coats 20, 22 around the perimeter of the second mold surface 16. The bond between the coats 20, 22 of the mold halves 11, 12 is more durable than a conventional head restraint having sewn seams because the bonding of the subject invention is particularly resistant to tearing, ripping, snagging and opening during repeated use over the life of the head restraint 50.

Referring now to FIGS. 9 and 10, a cellular foam filler 42 is then injected through the funnel 40 placed in fluid communication with the mold cavity 18. Alternatively, provided that the armatures 30 are hollow, the foam filler 42 may be injected through an opening formed in either or bot the armatures 30. An advantage of injecting the foam filler 42 through the armatures 30 is that the foam filler 42 has additional time to blend into a proper mixture.

As best shown in FIG. 10, the cellular foam filler 42 expands in the mold cavity 18 and bonds with the armatures 30 and the structural skin 29, formed by the coats 20, 22, to form the head restraint 50.

The foam filler 42 is preferably urethane and may be manufactured of a color that is complementary to the color of the structural skin 29, which provides the advantage of partially concealing any tears, cuts or breakage in the structural skin 29 that may occur during the life of the head restraint.

As a further alternative, provided that the armatures 30 utilize the U-shaped cross member 31 that is hollow, one of the armatures 30 may have inlet opening external to the cavity 18 and one or more fill holes in fluid communication with the cavity 18 for facilitating the injection of the foam filler 42. The other armature 30 may have an outlet opening external to the cavity 18 and one or more vent holes in fluid communication with the cavity 18 for facilitating the venting of gases. In this embodiment, the foam filler 42 is injected into the cavity 18 through the inlet opening via the fill holes, and gases escape the cavity 18 through outlet opening via the vent holes. It should be further appreciated that the injecting and venting may be further facilitated through apertures formed in the cross member having a hollow construction.

Preferably, the mold halves 11, 12 are manipulated 90 degrees before the injection of the foam filler 42 such that the armature 30 extends upwardly (as shown in FIG. 9). The 90-degree rotation assists in venting the mold cavity 18 during the foam injection.

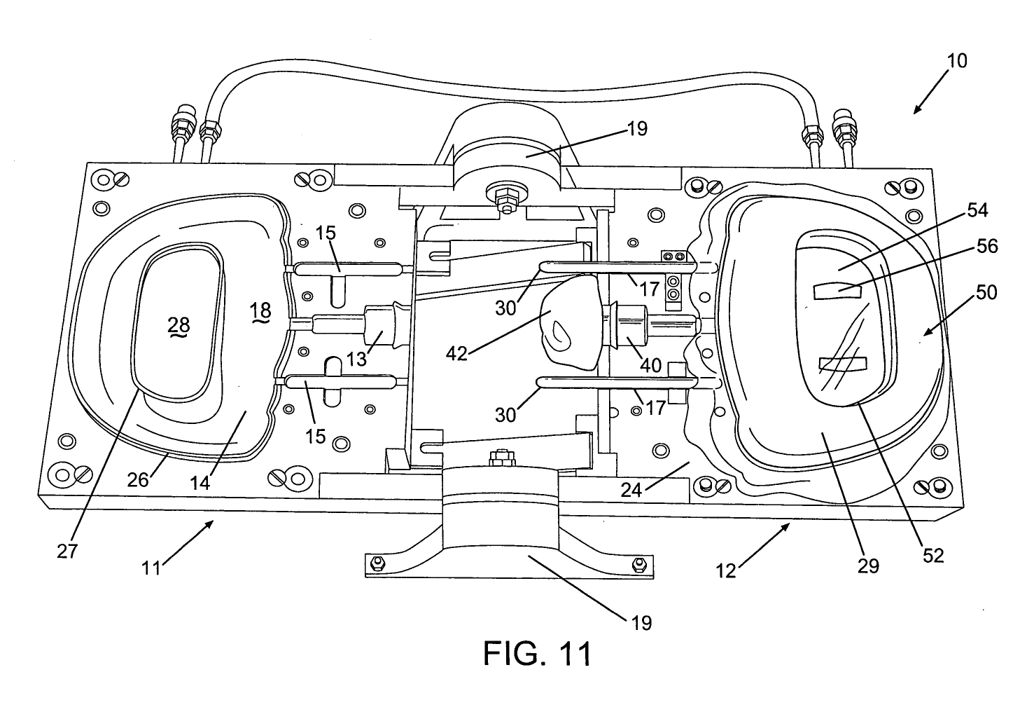

The foam filler 42 is allowed to expand in the mold cavity 18 and cure. Then, the mold halves 11, 12 are opened to remove the completed halo style head restraint 50, as shown in FIGS. 11 and 12. Finally, if necessary, the subject invention may include a step of deflashing excess structural skin 29 at the bonding line created between the mold halves 11, 12.

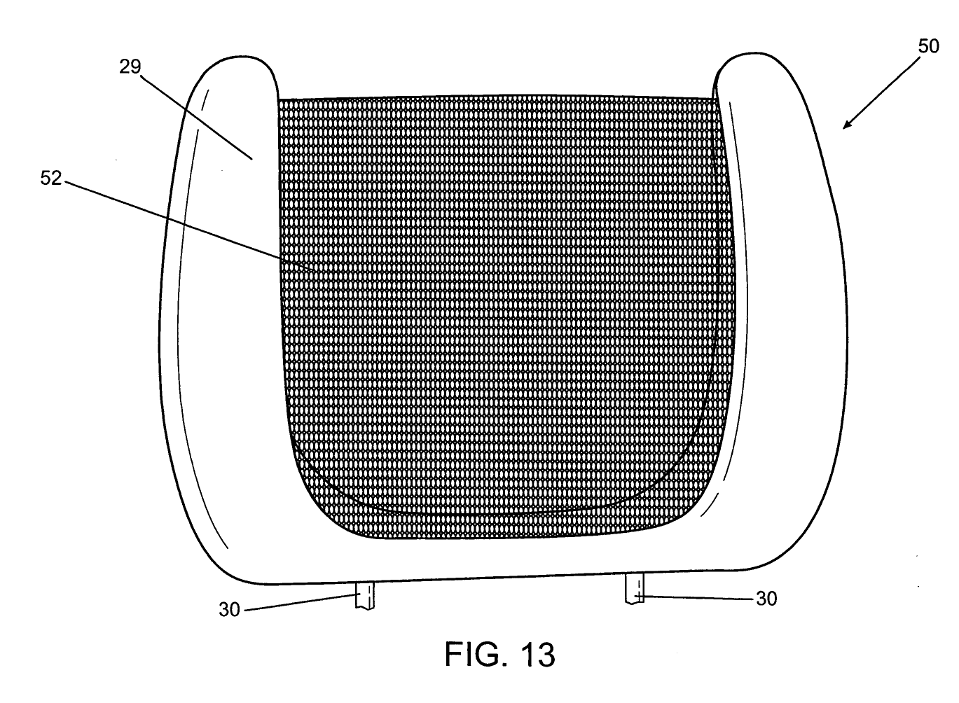

As mentioned earlier, the invention is not limited to a “halo” style head restraint design, and that the invention can be practiced with any open style head restraint design. For example, the invention can be practiced with a head restraint 50 in which the closeout 52 extends between a pair of armatures 30, as shown in FIG. 13. In this alternate embodiment, the need for the cross member 31 connecting the armatures 30 of the head restraint 50 together is eliminated.

While the invention has been specifically described in connection with certain specific embodiments thereof, it is to be understood that this is by way of illustration and not of limitation, and the scope of the appended claims should be construed as broadly as the prior art will permit.

1. An open style head restraint with a closeout, comprising:
one or more armatures and a cross member positioned between the one or more armatures forming an opening therebetween;
a closeout positioned within the opening of the head restraint,
wherein the closeout is supported by one of the one or more armatures and the cross member.

2. The head restraint according to claim 1, further including means for sealing the closeout from foam filler material during manufacture of the head restraint.

3. An open style head restraint with a closeout, comprising:
a pair of armatures forming an opening therebetween;
a closeout positioned within the opening,
wherein the closeout is supported by the pair of armatures.

4. The head restraint according to claim 3, further including means for sealing the closeout from foam filler material during manufacture of the head restraint.

5. A method for manufacturing an open style head restraint with a closeout, comprising the steps of:
supporting the closeout;
sealing the closeout from a foam filler material;
positioning the closeout in a mold assembly;
injecting the foam filler material in the mold assembly;
curing the foam filler material; and
removing the open style head restraint from the mold assembly.

6. The method of claim 5, wherein the closeout is sealed from the foam filler material by use of a substantially non-permeable material.

7. A mold assembly for manufacturing an open style head restraint with a closeout, comprising:
first and second mold halves movable between open and closed positions, one mold half including inner and outer cutting ridges, the other mold half including inner and outer projections aligned with the inner and outer cutting ridges,
wherein upon injecting foam filler material into at least one of the first and second mold halves, the foam filler material is sealed from the closeout of the open style head restraint.

8. The mold assembly according to claim 7, wherein the foam filler material is sealed from the closeout using a substantially non-permeable material.
